(19) United States
(12) Patent Application Publication
(10) Pub. No.: US 2024/0083411 A1
(43) Pub. Date: Mar. 14, 2024

(54) HYBRID ELECTRIC VEHICLE AND ENGINE OPERATION CONTROL METHOD THEREFOR

(71) Applicants: Hyundai Motor Company, Seoul (KR); Kia Corporation, Seoul (KR)

(72) Inventor: Joon Young Park, Seoul (KR)

(21) Appl. No.: 18/510,929

(22) Filed: Nov. 16, 2023

Related U.S. Application Data
(62) Division of application No. 17/094,985, filed on Nov. 11, 2020.

(30) Foreign Application Priority Data
Dec. 16, 2019 (KR) 10-2019-0168099

(51) Int. Cl. B60W 20/15; B60W 10/06; B60W 10/08; B60W 20/12; B60W 20/16; B60W 40/09; B60W 50/00; F02D 41/06; G01C 21/34; G01C 21/36

(52) U.S. Cl. CPC B60W 20/15; B60W 10/06; B60W 10/08; B60W 20/12; B60W 20/16; B60W 40/09; B60W 50/0097; F02D 41/068; G01C 21/3492; G01C 21/3691; B60W 2540/30; B60W 2552/05; B60W 2552/20; B60W 2555/60

(57) ABSTRACT

An embodiment provides an engine operation control method for a hybrid electric vehicle. The method includes determining a necessity for warm up control for an engine, determining whether a current position corresponds to a specific zone upon determining that the warm up control is necessary, determining whether driving power of the engine is required until the hybrid electric vehicle exits the specific zone when the current position corresponds to the specific zone, performing the warm up control after the hybrid electric vehicle exits the specific zone when the driving power of the engine is not required in the specific zone, and performing the warm up control before arrival at a time or a point at which the driving power of the engine is required when the driving power of the engine is required in the specific zone.

### CROSS-REFERENCE TO RELATED APPLICATIONS

This application is a divisional of U.S. patent application Ser. No. 17/094,985, filed Nov. 11, 2020, which claims the benefit of Korean Application No. 10-2019-0168099, filed on Dec. 16, 2019, which applications are hereby incorporated herein by reference.

### TECHNICAL FIELD

The present invention relates to a hybrid electric vehicle and an engine operation control method therefor.

### BACKGROUND

Hybrid electric vehicles (HEVs) are vehicles using two power sources, in general, and the two power sources are mainly an engine and an electric motor. Such hybrid electric vehicles have higher fuel efficiency and dynamic performance than vehicles including only an internal combustion engine and are advantageous for exhaust gas reduction and thus have recently been widely developed.

Such a hybrid electric vehicle can travel in two driving modes according to which powertrain is driven. One of the two driving modes is an electric vehicle (EV) mode in which driving is performed using only an electric motor and the other mode is a hybrid electric vehicle (HEV) mode in which both an electric motor and an engine are operated to obtain power. Hybrid electric vehicles switch between the two modes depending on driving conditions.

In general hybrid electric vehicles, control for engine warm-up or catalyst heating is performed for exhaust gas reduction in the initial stage of engine operation at the time of switching to the HEV mode. Catalyst heating is performed using heat of combustion of an engine. When a vehicle is parked for a predetermined time or longer, the engine is maintained at a normal temperature and thus the engine operates for catalyst heating when a driver presses a start button. More specifically, for catalyst heating and engine warm-up, the engine needs to be driven with low load (at a specific speed and specific torque or less) for appropriate temperature increase control (i.e., warm up control). Accordingly, appropriate system efficiency and battery state of charge (SOC) can be maintained by operating the engine with low load and providing remaining driving power through the electric motor when required power is low. However, in a case where required power is high in a situation in which warm up control is not completed, engine power needs to be inevitably actively used in order to obtain satisfactory driving power and system efficiency, which deteriorates exhaust performance.

If a vehicle is parked in an indoor space, particularly, a narrow garage, a driver feels unpleasant because exhaust gases having large pollutant content are discharged until a catalyst for exhaust gas purification is heated. This situation can be resolved when the driving mode is switched to the EV mode, but the driver needs to perform an operation for switching to the EV mode for mode switching. Furthermore, in general hybrid electric vehicles, it is difficult for a driver to recognize whether a catalyst is heated and it is cumbersome to perform an operation of manually switching to the EV mode whenever the catalyst is heated in an unwanted situation.

Particularly, it is not desirable to perform catalyst heating in an engine operation restriction area (hereinafter referred to as a “green zone”) in which exhaust gas emission is regulated, such as schools, hospitals and residential areas in which atmospheric environments for pedestrians need to be improved. This will be described in detail below.

In a driving strategy of a hybrid electric vehicle in a green zone, a distance which the vehicle can travel using only an electric motor is secured within the green zone by lowering an engine operation criterion in advance and charging a battery before the vehicle enters the green zone in order to prevent engine operation, and engine operation is limited within the green zone by raising the engine operation criterion after the vehicle enters the green zone.

However, in a case where a hybrid electric vehicle is started within a green zone, engine operation is not desired although engine warm-up or catalyst heating is necessary for exhaust gas reduction. This will be described with reference to FIGS. 1A and 1B.

FIGS. 1A and 1B are diagrams for describing a problem when a vehicle starts to travel in a green zone.

Referring to FIG. 1A, when warm up control such as catalyst heating (CH) or engine warm-up (Wup) is performed immediately upon starting of the vehicle in a green zone, normal engine operation can be performed in a zone outside the green zone, in which a required load exceeds an EV limit load (i.e., a driving load that can be managed by only a motor). However, it is not desirable that exhaust gases be emitted upon starting of the vehicle in the green zone.

However, if catalyst heating or engine warm-up is inhibited in the green zone, there is a problem that excessive exhaust gases are emitted due to active engine operation in a situation in which catalyst heating or engine warm-up has not been performed when there is a zone in which a driving load exceeds the EV limit load adjacent to the green zone as shown in FIG. 1B.

Accordingly, it is necessary to perform catalyst heating and engine warm-up at an appropriate time in order to minimize side effects from exhaust gas emission.

### SUMMARY

The present invention relates to a hybrid electric vehicle and an engine operation control method therefor. Particular embodiments relate to a hybrid electric vehicle and a control method thereof which can perform engine warm-up or catalyst heating before a time when engine power is required.

An embodiment of the present invention provides a method for preparing for engine operation in consideration of a driving situation and a hybrid electric vehicle performing the same.

It will be appreciated by persons skilled in the art that the features that could be achieved with embodiments of the present invention are not limited to what has been particularly described hereinabove and the above and other features that embodiments of the present invention could achieve will be more clearly understood from the following detailed description.

In accordance with an embodiment of the invention, an engine operation control method for a hybrid electric vehicle may include determining necessity for warm up control for an engine, determining a time required for the warm up control upon determining that the warm up control is necessary, predicting driving conditions in a predetermined forward range, determining a time or a point at which driving power of the engine is required in the predicted driving conditions, determining a control start time or a control start point at which the warm up control is completed before arrival at the determined time or point at which the driving power of the engine is required on the basis of the time required for the warm up control, and starting the warm up control upon arrival at the control start time or the control start point.

Furthermore, an engine operation control method for a hybrid electric vehicle according to an embodiment of the present invention may include determining necessity for warm up control for an engine, determining whether a current position corresponds to a specific zone upon determining that the warm up control is necessary, determining whether driving power of the engine is required until the hybrid electric vehicle exits the specific zone when the current position corresponds to the specific zone, performing the warm up control after the hybrid electric vehicle exits the specific zone when the driving power of the engine is not required in the specific zone, and performing the warm up control before arrival at a time or a point at which the driving power of the engine is required when the driving power of the engine is required in the specific zone.

Furthermore, a hybrid electric vehicle according to an embodiment of the present invention may include an engine control unit for determining a time required for warm up control for an engine when the warm up control is necessary, a driving pattern storage unit for predicting driving conditions in a predetermined forward range, and a hybrid controller unit for determining a time or a point at which driving power of the engine is required in the predicted driving conditions, determining a control start time or a control start point at which the warm up control is completed before arrival at the determined time or point at which the driving power of the engine is required on the basis of the time required for the warm up control, and controlling the warm up control to be executed upon arrival at the control start time or the control start point.

In addition, a hybrid electric vehicle according to an embodiment of the present invention may include an engine control unit for determining necessity for warm up control for an engine, and a hybrid controller unit for determining whether a current position corresponds to a specific zone upon determining that the warm up control is necessary, determining whether driving power of the engine is required until the hybrid electric vehicle exits the specific zone when the current position corresponds to the specific zone, controlling the warm up control to be executed after the hybrid electric vehicle exits the specific zone when the driving power of the engine is not required in the specific zone, and controlling the warm up control to be executed before arrival at a time or a point at which the driving power of the engine is required when the driving power of the engine is required in the specific zone.

The hybrid electric vehicle according to at least one embodiment of the present invention configured as above can perform preparation for engine operation, such as catalyst heating or engine warm-up, in consideration of a surrounding situation.

Particularly, it is possible to effectively perform preparation for engine operation before a time at which engine driving power is required in consideration of conditions such as whether a current position of a vehicle belongs to a specific zone, when engine driving power is required in a predicted driving condition, how long engine operation preparation will take, and the like.

It will be appreciated by persons skilled in the art that the effects that can be achieved with embodiments of the present invention are not limited to what has been particularly described hereinabove and other advantages of embodiments of the present invention will be more clearly understood from the following detailed description.

### BRIEF DESCRIPTION OF THE DRAWINGS

FIGS. 1A and 1B are diagrams for describing a problem when a vehicle starts to travel in a green zone.

FIG. 2 illustrates an example of a powertrain structure of a hybrid electric vehicle to which embodiments of the present invention are applicable.

FIG. 3 is a block diagram illustrating an example of a control system of the hybrid electric vehicle to which embodiments of the present invention are applicable.

FIG. 4 is a block diagram illustrating an example of a vehicle structure for performing engine operation control according to an embodiment of the present invention.

FIGS. 5A to 5E are diagrams for describing an engine operation control process according to an embodiment of the present invention.

FIG. 6 is a flowchart illustrating an example of a process of performing engine operation control according to an embodiment of the present invention.

FIG. 7 is a diagram for describing effects of engine operation control according to an embodiment of the present invention.

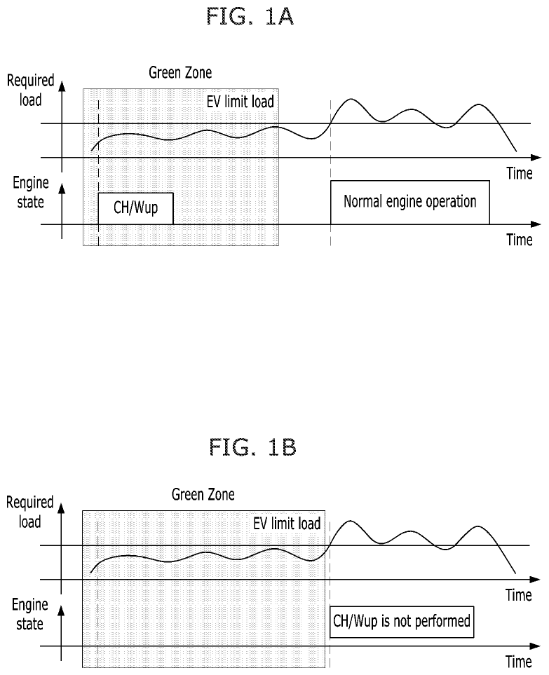

### DETAILED DESCRIPTION OF ILLUSTRATIVE EMBODIMENTS

The detailed description of the exemplary embodiments of the present invention will be given to enable those skilled in the art to implement and practice the invention with reference to the attached drawings. However, the present invention can be implemented in various different forms and is not limited to embodiments described herein. In addition, parts that are not related to the description will be omitted for clear description in the drawings, and the same reference numbers will be used throughout this specification to refer to the same or like parts.

Throughout the specification, when it is said that some part “includes” a specific element, this means that the part may further include other elements, not excluding the same, unless mentioned otherwise. In addition, parts denoted by the same reference numeral refer to the same component throughout the specification.

In embodiments of the present invention, a method for determining a point or a time at which an engine needs to be actively used on the basis of driving load of a predicted driving route and completing warm up control before arrival at the point or time is proposed.

Prior to description of an engine operation control method according to embodiments of the present invention, a structure and a control system of a hybrid electric vehicle according to embodiments, and the concept of a zone affected by exhaust gas emission, will be described.

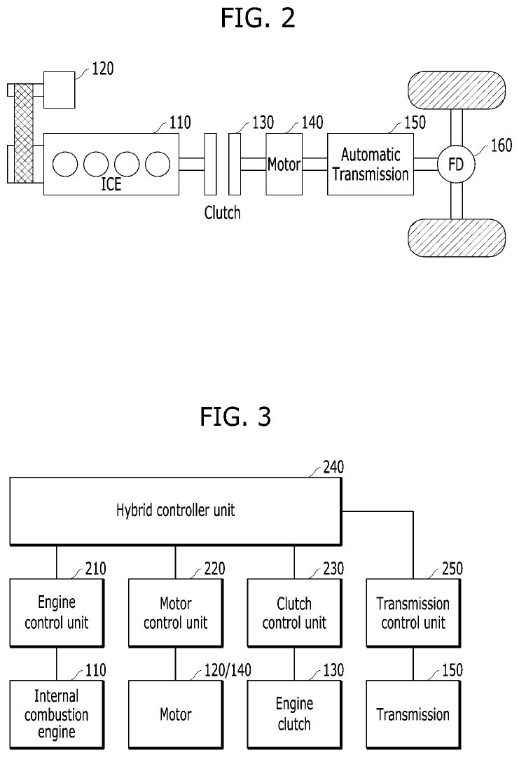

FIG. 2 illustrates an example of a powertrain structure of a hybrid electric vehicle to which embodiments of the present invention are applicable.

FIG. 2 illustrates a powertrain of a hybrid electric vehicle employing a parallel type hybrid system in which an electric motor (or a drive motor) 140 and an engine clutch (EC) 130 are provided between an internal combustion engine (ICE) 110 and a transmission 150.

In this vehicle, when a driver depresses an accelerator pedal after starting, the motor 140 operates using battery power in a state in which the engine clutch 130 is opened and the power of the motor is transmitted to the transmission 150 and a final drive (FD) 160 to move wheels (i.e., EV mode). When the vehicle requires higher driving power due to gradually increasing speed, an auxiliary motor (or starter generator 120) can operate to drive the engine 110.

When the rotation speed of the engine 110 becomes identical to the rotation speed of the motor 140, the engine clutch 130 is engaged such that the engine 110 and the motor 140 drive the vehicle together or the engine 110 drives the vehicle (i.e., transition from the EV mode to an HEV mode). When predetermined engine off conditions including vehicle speed reduction are satisfied, the engine clutch 130 is opened and the engine 110 stops (i.e., transition from the HEV mode to the EV mode). Further, in the hybrid electric vehicle, the driving power of the wheels can be converted into electric energy during braking to charge a battery, which is referred to as braking energy regeneration or regenerative braking.

The starter generator 120 serves as a starter motor when the engine is started and serves as a generator after the engine is started or rotation energy of the engine is recovered when the engine is turned off, and thus may be referred to as a “hybrid starter generator (HSG)”. The starter generator 120 may also be referred to as an “auxiliary motor” as necessary.

Correlation between control units in a vehicle to which the above-described powertrain is applied is illustrated in FIG. 3.

FIG. 3 is a block diagram illustrating an example of a control system of a hybrid electric vehicle to which embodiments of the present invention are applicable.

Referring to FIG. 3, in the hybrid electric vehicle to which embodiments of the present invention are applicable, the internal combustion engine 110 may be controlled by an engine control unit 210, torques of the starter generator 120 and the electric motor 140 may be controlled by a motor control unit (MCU) 220, and the engine clutch 130 may be controlled by a clutch control unit 230. Here, the engine control unit 210 may also be called an engine management system (EMS). Further, the transmission 150 is controlled by a transmission control unit 250. A control unit for the starter generator 120 and a control unit for the electric motor 140 may be separately provided as necessary.

Each control unit may be connected to a hybrid controller unit 240 which is a higher control unit and controls a mode switching process and may provide information necessary to change driving modes and to control the engine clutch during gear shifting and/or information necessary for engine stop control to the control units under the control of the hybrid controller unit 240 or perform an operation according to a control signal.

More specifically, the hybrid controller unit 240 determines whether to perform mode switching according to a driving state of the vehicle. For example, the hybrid controller unit 240 determines an open time of the engine clutch 130 and performs hydraulic control (in the case of a wet engine clutch) or torque capacity control (in the case of a dry EC) when the engine clutch 130 is opened. Further, the hybrid controller unit 240 may determine a state (lock-up, slip, open, or the like) of the engine clutch 130 and control a fuel injection stop time of the engine 110. Further, the hybrid controller unit may transmit a torque command for controlling the torque of the starter generator 120 for engine stop control to the motor control unit 220 to control recovery of engine rotation energy. In addition, the hybrid controller unit 240 can control lower control units for engine operation control and mode switching control according to embodiments of the present invention which will be described later.

The above-described correlation between control units and the function/definition of each control unit are exemplary and it is obvious to those skilled in the art that the control units are not limited by the names thereof. For example, the hybrid controller unit 240 may be realized such that any one of other control units provides the functions of the hybrid controller unit 240 or two or more other control units may provide the functions in a distributed manner.

Next, the concept of a green zone will be described.

A green zone may be an engine operation restriction area in which exhaust gas emission is regulated for the purpose of improving the atmospheric environment for pedestrians. The green zone may be a preset area or may be variably set according to a current/recent situation. Here, a preset area may correspond to an area set by regulations or government policy (e.g., an exhaust gas management area of London or Seoul), an area where exhaust gas reduction is necessary due to regional characteristics (e.g., a child protection zone, an indoor parking lot, a residential area, a park, a drive-through, a hospital, etc.), and the like. In addition, a variably set area may correspond to an area in which current settings can be checked through RF information such as telematics, a pedestrian-concentrated area determined through a vision information acquisition device (ADAS system or the like) included in a vehicle, and the like. Specifically, a specific area in which an atmospheric condition determined to deteriorate with reference to atmospheric environment information, an area determined to be a pedestrian-concentrated area on the basis of big data using position information of a smartphone, and an area in which a large amount of exhaust gases is estimated to be generated on the basis of vehicle average speeds and traffic collected through a telematics service may correspond to variably set areas.

Furthermore, an area affected by exhaust gas emission may be set in units of an arbitrary administrative district, set as a zone connecting a plurality of coordinates that are boundary points, or set as a specific facility/part thereof or a zone within a specific radial distance from specific facility/coordinates.

The above-described examples are exemplary and embodiments of the present invention are not limited to setting criteria, setting ranges and setting periods of such areas.

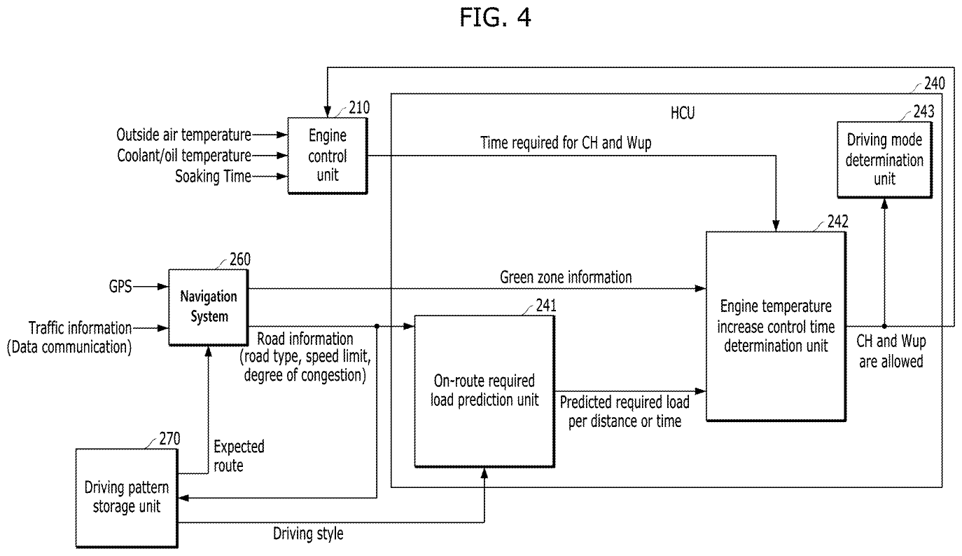

Next, a vehicle configuration for performing engine operation control according to an embodiment will be described with reference to FIG. 4.

FIG. 4 is a block diagram illustrating an example of a vehicle configuration for performing engine operation control according to an embodiment of the present invention.

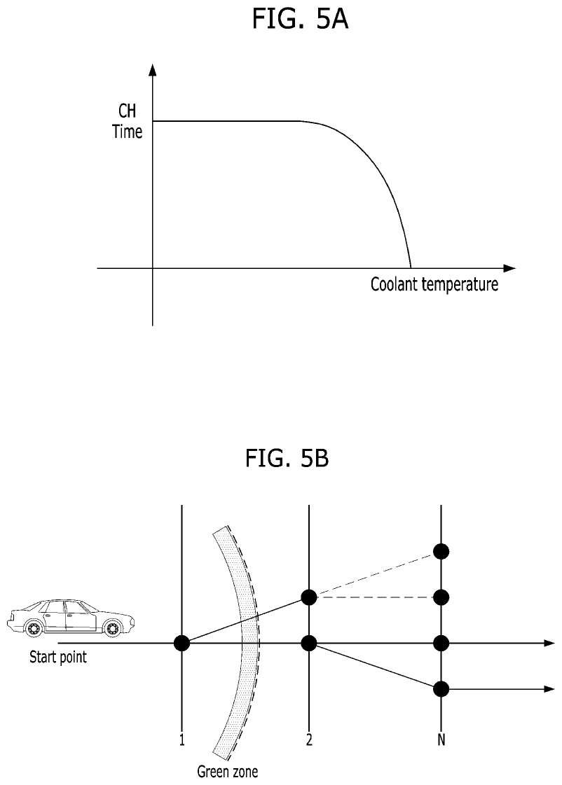

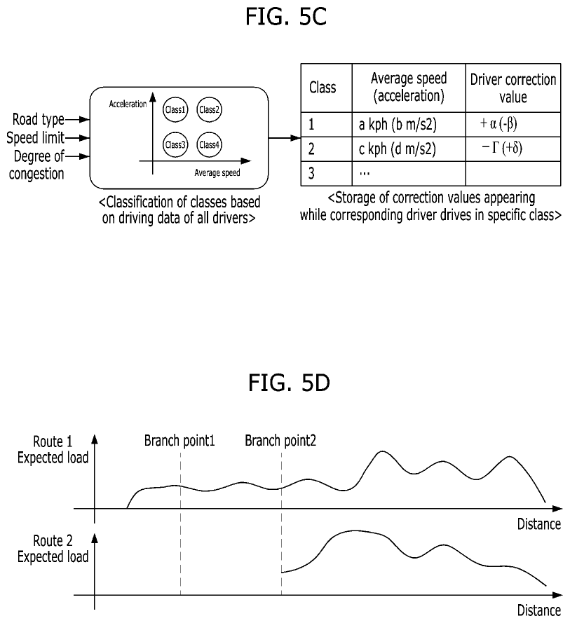

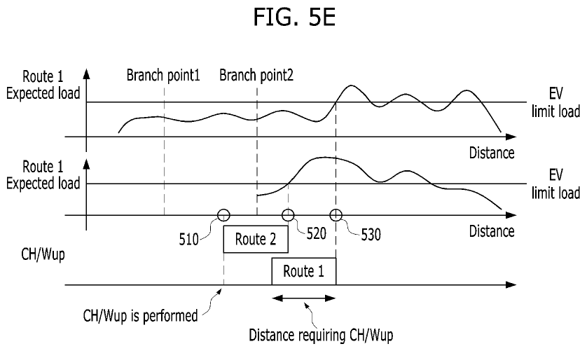

Referring to FIG. 4, for engine operation control according to an embodiment, a hybrid electric vehicle may include the engine control unit 210, the hybrid controller unit 240, a navigation system 260, and a driving pattern storage unit 270. The configuration illustrated in FIG. 4 shows components related to engine operation control, and it is obvious to those skilled in the art that the hybrid electric vehicle may further include the components illustrated in FIGS. 2 and 3 in actual implementation. Hereinafter, the operation of each component will be described in detail with reference to FIGS. 5A to 5E as necessary. FIGS. 5A to 5E are diagrams for describing an engine operation control process according to an embodiment of the present invention.

First, the engine control unit 210 can predict a time required for temperature increase control, that is, catalyst heating (CH) and warm-up (Wup), through modeling with respect to temperature increase control related characteristics. To this end, the engine control unit 210 may use at least one state factor related to temperature increases, such as outside air temperature, coolant temperature, oil temperature, batch catalyst temperature and soaking time. For example, when coolant temperature is used, the engine control unit 210 can use a catalyst heating time (CH time) graph according to coolant temperature or a table corresponding thereto.

The driving pattern storage unit 270 can predict an expected route after engine start. For an expected route, expected route candidates can be determined by detecting branch points within a specific distance from a start point and using a departure date/time/statistical data for each driver, a route set by a driver, digital library based schedule information, and the like, as illustrated in FIG. 5B. If there is no or insufficient information necessary for route prediction, all route branch points may be set as route candidates.

In addition, the driving pattern storage unit 270 can classify driving routes into a plurality of classes according to average speeds and acceleration on the basis of road information such as road types, speed limits, and degrees of congestion and store a correction value to be applied to a speed/acceleration per class depending on the driver's driving style, as illustrated in FIG. 5C. In other words, the driving pattern storage unit 270 can cumulatively learn correction values appearing when the corresponding driver drives the vehicle along a route corresponding to a specific class.

The hybrid controller unit 240 may include an on-route required load prediction unit 241, an engine temperature increase control time determination unit 242, and a driving mode determination unit 243.

The on-route required load prediction unit 241 can predict driving load profiles by reflecting driver correction values of the driving pattern storage unit 270 in average load on the basis of map information and traffic information of the navigation system 260 for each expected route candidate, as illustrated in FIG. 5D. Here, when route 1 and route 2 are the same route before branch point 2, as shown in FIG. 5D, calculation with respect to a section in which expected load has been calculated may be omitted for one route (e.g., route 1).

The engine temperature increase control time determination unit 242 can convert a time necessary for temperature increase, predicted by the engine control unit 210, into a distance on the basis of a predicted vehicle speed (i.e., an average speed until a time or a point at which the driving power of the engine is required) of each expected route candidate and set a temperature increase control section such that temperature increase control can be completed immediately before expected load for each route reaches load that requires engine operation (i.e., EV limit load). Here, “immediately before” may mean that a distance or a time interval between a point/time at which temperature increase control is completed and a point/time at which engine operation is required is within a predetermined distance or time (e.g., 100 m or 10 seconds).

Here, in a case where temperature increase control section start times/points are different for respective expected routes, execution of temperature increase control may be determined on the basis of a temperature increase control section that starts first. This will be described with reference to FIG. 5E.

Referring to FIG. 5E, an EV limit load point 520 of route 2 arrives prior to an EV limit load point 530 of route 1, and thus a temperature increase control section of route 2 starts first. In this case, the engine temperature increase control time determination unit 242 can determine execution of temperature increase control on the basis of a point 510 that precedes the EV limit load point 520 of route 2 by a distance necessary for temperature increase control, that is, the temperature increase control section start point 510 of route 2.

Thereafter, upon arrival at a temperature increase control start point/time with reference to the navigation system 260, the engine temperature increase control time determination unit 242 can notify the driving mode determination unit 243 of switching to the HEV mode and notify the engine control unit 210 of permission for temperature increase control. Accordingly, the engine control unit 210 can increase the temperature of the engine 110 through idle control or the like.

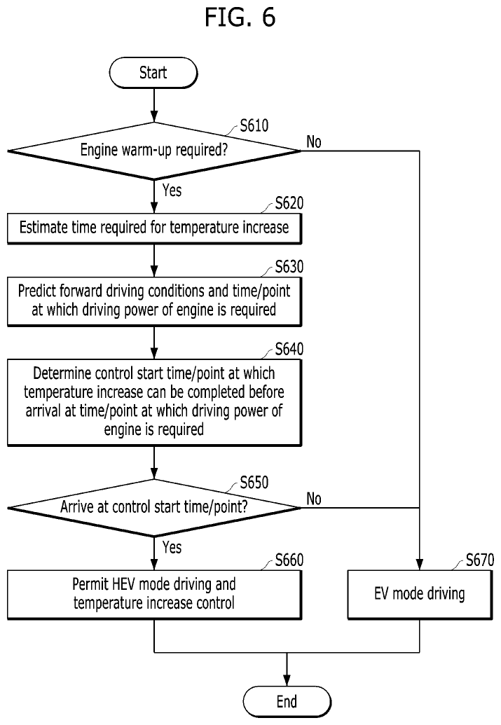

The engine operation control process according to the above-described embodiment is arranged as a flowchart in FIG. 6.

FIG. 6 is a flowchart illustrating an example of a process of performing engine operation control according to an embodiment of the present invention.

Referring to FIG. 6, the engine control unit 210 may determine whether engine warm-up is required on the basis of coolant temperature, oil temperature, and the like (S610) and estimate a time required for warm-up on the basis of engine modeling (S620).

The driving pattern storage unit 270 may provide expected routes and driving style information depending thereon to the hybrid controller unit 240, and the hybrid controller unit 240 may predict a time or a point at which the driving power of the engine is required by predicting required load for each expected route on the basis of forward driving conditions such as the expected routes, the driving style information, and traffic information (S630). Here, the forward driving conditions may include expected routes within a predetermined required time or a predetermined distance from a start point (or current position). Further, the traffic information may include road types, speed limits, gradients, degrees of congestion, and the like. The driving pattern storage unit 270 may be implemented in the form of a function or a module in the hybrid controller unit 240, implemented as a cloud server outside the vehicle, or implemented as a separate control unit for the corresponding function.

In addition, the hybrid controller unit 240 may determine temperature increase control start times at which temperature increase control can be completed before a time at which the driving power of the engine is required for respective expected routes in consideration of the time required for temperature increase at a point where the driving power of the engine is required and determine a control start time/point that starts first as a final temperature increase control start time/point (S640).

Subsequently, the hybrid controller unit 240 may check a current position, i.e., determine arrival at the control start time/point (S650), maintain the EV mode until arrival at the determined temperature increase control start time/point (S670), and switch the EV mode to the HEV mode and permit temperature increase control upon arrival at the determined temperature increase control start time/point (S660).

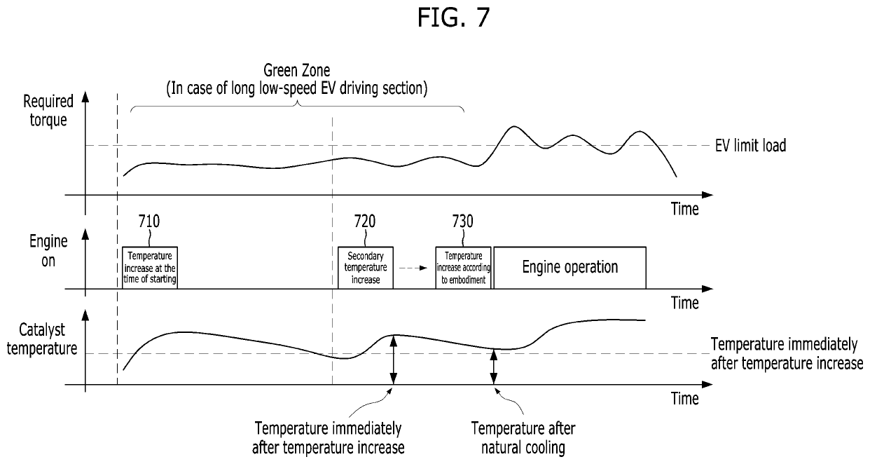

FIG. 7 is a diagram for describing effects of engine operation control according to an embodiment of the present invention.

Referring to FIG. 7, in a case where a general hybrid electric vehicle starts in a green zone, temperature increase control 710 is performed upon starting of the vehicle, and secondary temperature increase control 720 is performed when catalyst temperature increased through the temperature increase control 710 decreases to be lower than a criterion for temperature increase. As a result, temperature increase control is performed twice (710 and 720) before the hybrid electric vehicle exits the green zone, and temperature increased through secondary temperature increase control 720 may decrease according to natural cooling when the hybrid electric vehicle arrives at a zone having driving load exceeding the EV limit load, which is not desirable for efficiency or exhaust gas emission. However, according to an embodiment, engine temperature increase control 730 is performed once before the hybrid electric vehicle arrives at a zone having driving load exceeding the EV limit load, and thus it is possible to avoid a situation in which temperature increase control is unconditionally performed upon starting of the vehicle or temperature increase control is repeatedly performed.

Meanwhile, although a temperature control time or point has been determined on the basis of a time/point at which engine operation is required in the above-described embodiments, it may be determined whether to perform temperature increase control on the basis of whether a point at which engine operation is required is included in a green zone. For example, the hybrid controller unit 240 may determine whether an expected route until the vehicle exits a green zone includes a point at which engine operation is required when the current position of the vehicle is in the green zone and determine execution of temperature increase control after the vehicle exits the green zone when the expected route does not include a point at which engine operation is required. On the other hand, when the green zone includes a point at which engine operation is required, the engine operation control method according to the above-described embodiments can be used.

The above-described present invention can be realized as computer-readable code in a medium in which a program is recorded. Computer-readable media include all kinds of recording devices in which data readable by computer systems is stored. Examples of computer-readable media include a hard disk drive (HDD), a solid state drive (SSD), a silicon disk drive (SYD), a read-only memory (ROM), a random access memory (RAM), a compact disc read-only memory (CD-ROM), a magnetic tape, a floppy disk, an optical data storage device, etc.

Therefore, the above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An engine operation control method for a hybrid electric vehicle, the method comprising:
determining a necessity for warm up control for an engine;
determining whether a current position corresponds to a specific zone upon determining that the warm up control is necessary;
determining whether driving power of the engine is required until the hybrid electric vehicle exits the specific zone when the current position corresponds to the specific zone;
performing the warm up control after the hybrid electric vehicle exits the specific zone when the driving power of the engine is not required in the specific zone; and
performing the warm up control before arrival at a time or a point at which the driving power of the engine is required when the driving power of the engine is required in the specific zone.

2. The method according to claim 1, wherein the specific zone includes a zone in which exhaust gas emission reduction is enforced or recommended.

3. The method according to claim 1, wherein the specific zone comprises a green zone encompassing an area set by regulations or government policy.

4. The method according to claim 1, wherein the specific zone comprises a green zone encompassing an area where exhaust gas reduction is recommended due to regional characteristics.

5. The method according to claim 1, wherein the specific zone comprises a pedestrian-concentrated area determined through a vision information acquisition device included in the vehicle.

6. The method according to claim 1, wherein the warm up control has characteristics related to temperature increase in coolant temperature.

7. The method according to claim 1, wherein the warm up control has characteristics related to temperature increase in oil temperature.

8. The method according to claim 1, wherein the warm up control has characteristics related to temperature increase in catalyst temperature of the engine.

9. The method according to claim 1, wherein the warm up control has characteristics related to temperature increase in coolant temperature, oil temperature and catalyst temperature of the engine.

10. A hybrid electric vehicle, comprising:
an engine control unit configured to determine necessity for warm up control for an engine; and
a hybrid controller unit configured to determine whether a current position corresponds to a specific zone upon determining that the warm up control is necessary, determine whether driving power of the engine is required until the hybrid electric vehicle exits the specific zone when the current position corresponds to the specific zone, control the warm up control to be executed after the hybrid electric vehicle exits the specific zone when the driving power of the engine is not required in the specific zone, and control the warm up control to be executed before arrival at a time or a point at which the driving power of the engine is required when the driving power of the engine is required in the specific zone.

11. The hybrid electric vehicle according to claim 10, wherein the specific zone includes a zone in which exhaust gas emission reduction is enforced or recommended.

12. The hybrid electric vehicle according to claim 11, wherein the specific zone comprises a green zone encompassing an area set by regulations or government policy.

13. The hybrid electric vehicle according to claim 11, wherein the specific zone comprises a green zone encompassing an area where exhaust gas reduction is recommended due to regional characteristics.

14. The hybrid electric vehicle according to claim 10, further comprising a vision information acquisition device, wherein the specific zone comprises a pedestrian-concentrated area determined through the vision information acquisition device.

15. The hybrid electric vehicle according to claim 10, wherein the warm up control has characteristics related to temperature increase in coolant temperature.

16. The hybrid electric vehicle according to claim 10, wherein the warm up control has characteristics related to temperature increase in oil temperature.

17. The hybrid electric vehicle according to claim 10, wherein the warm up control has characteristics related to temperature increase in catalyst temperature of the engine.

18. The hybrid electric vehicle according to claim 10, wherein the warm up control has characteristics related to temperature increase in coolant temperature, oil temperature and catalyst temperature of the engine.

19. An engine operation control method for a hybrid electric vehicle, the method comprising:
determining a necessity for warm up control for an engine;
determining boundaries of a green zone where exhaust gas emission is to be reduced;
determining whether a current position corresponds to the green zone upon determining that the warm up control is necessary;
determining whether driving power of the engine is required until the hybrid electric vehicle exits the green zone when the current position corresponds to the green zone;
performing the warm up control after the hybrid electric vehicle exits the green zone when the driving power of the engine is not required in the green zone; and
performing the warm up control before arrival at a time or a point at which the driving power of the engine is required when the driving power of the engine is required in the green zone.

20. The method according to claim 19, wherein determining the boundaries of the green zone comprises using a vision information acquisition device to determine a pedestrian-concentrated area.
